(19) United States
(12) Patent Application Publication
(10) Pub. No.: US 2026/0297385 A1
(43) Pub. Date: Oct. 1, 2026

(54) ADHESIVE COMPOSITION AND BONDED OBJECT

(71) Applicant: Resonac Corporation, Tokyo (JP)

(72) Inventors: Takeshi MASAKI, Tokyo (JP); Masahiro MATSUNAGA, Tokyo (JP); Takashi KAWAMORI, Tokyo (JP)

(21) Appl. No.: 19/479,413

(22) PCT Filed: Dec. 10, 2024
(86) PCT No.: PCT/JP2024/043684

§ 371 Date: Oct. 28, 2025

(30) Foreign Application Priority Data
Dec. 12, 2023 (JP) 2023-209503

(51) Int. Cl. C09J 4/06; C09J 11/06; C09J 133/06

(52) U.S. Cl. CPC C09J 4/06; C09J 11/06; C09J 133/066

(57) ABSTRACT

An adhesive composition containing a monofunctional (meth)acrylate compound, a polyfunctional (meth)acrylate compound, an epoxy compound, a cross-linking agent, and a photoacid generator is disclosed. The monofunctional (meth)acrylate compound includes a (meth)acrylate having a fluorine-containing organic group. The cross-linking agent includes a (meth)acrylic resin having a first structural unit derived from a (meth)acrylate having a fluorine-containing organic group, and a second structural unit derived from a (meth)acrylate having a cyclic ether group.

### TECHNICAL FIELD

The present disclosure relates to an adhesive composition and a bonded object.

### BACKGROUND ART

As an adhesive composition, a photocurable composition containing a (meth)acrylate compound, an epoxy compound, and a photoacid generator is known (see, for example, Patent Literature 1).

### CITATION LIST

### Patent Literature

Patent Literature 1: JP 2018-141137 A

### SUMMARY OF INVENTION

### Technical Problem

Polymers of compounds having a fluorine-containing organic group have attracted attention as materials exhibiting a low refractive index. The present inventors focused on an adhesive composition containing a (meth)acrylate compound, an epoxy compound, and a photoacid generator. Through studying the curing reaction of this composition using a (meth)acrylate having a fluorine-containing organic group, they found that the adhesive strength of a cured product of the adhesive composition tends to decrease significantly after a damp heat test (for example, a durability test under conditions of a temperature of 85° C., a humidity of 85% RH, and a time of 168 hours).

A main objective of the present disclosure is to provide an adhesive composition capable of providing a cured product in which adhesive strength is sufficiently maintained before and after a damp heat test.

### Solution to Problem

As a result of diligent studies by the present inventors to solve the above problem, they found that by combining a monofunctional (meth)acrylate compound and a polyfunctional (meth)acrylate compound in a predetermined adhesive composition, a cured product in which adhesive strength is sufficiently maintained before and after a damp heat test can be obtained, and have completed the invention of the present disclosure.

The present disclosure includes the following [1] to [5].
[1] An adhesive composition, containing: a monofunctional (meth)acrylate compound; a polyfunctional (meth)acrylate compound; an epoxy compound; a cross-linking agent; and a photoacid generator, wherein
   the monofunctional (meth)acrylate compound includes a (meth)acrylate having a fluorine-containing organic group, and
   the cross-linking agent includes a (meth)acrylic resin having a first structural unit derived from a (meth)acrylate having a fluorine-containing organic group, and a second structural unit derived from a (meth)acrylate having a cyclic ether group.
[2] The adhesive composition according to [1], wherein
   the polyfunctional (meth)acrylate compound includes a trifunctional or higher (meth)acrylate compound.
[3] The adhesive composition according to [1] or [2], wherein
   the epoxy compound includes an aliphatic epoxy compound.
[4] The adhesive composition according to [3], wherein
   the epoxy compound further includes an alicyclic epoxy compound.
[5] A bonded object, including: a first adherend; a second adherend; and an adhesive part that bonds the first adherend and the second adherend to each other, wherein
   the adhesive part contains a cured product of the adhesive composition according to any one of [1] to [4].

### Advantageous Effects of Invention

According to the present disclosure, an adhesive composition capable of providing a cured product in which adhesive strength is sufficiently maintained before and after a damp heat test is provided. Further, according to the present disclosure, a bonded object using such an adhesive composition is provided.

### DESCRIPTION OF EMBODIMENTS

Hereinafter, embodiments of the present disclosure will be described. However, the present disclosure is not limited to the following embodiments.

In the present specification, a numerical range indicated using “to” indicates a range including the numerical values described before and after “to” as the minimum value and the maximum value, respectively. In a numerical range described in stages in the present specification, the upper limit value or the lower limit value of a numerical range of one stage may be replaced with the upper limit value or the lower limit value of a numerical range of another stage. Further, in a numerical range described in the present specification, the upper limit value or the lower limit value of the numerical range may be replaced with a value shown in the examples. Further, individually described upper limit values and lower limit values can be arbitrarily combined. In the notation of a numerical range “A to B”, the numerical values A and B at both ends are included in the numerical range as the lower limit value and the upper limit value, respectively. In the present specification, for example, the description “10 or more” means “10” and “a numerical value exceeding 10”, and the same applies when the numerical value is different. Further, for example, the description “10 or less” means “10” and “a numerical value less than 10”, and the same applies when the numerical value is different.

In the present specification, a (meth)acrylate compound means a compound having one or more (meth)acryloyl groups, a monofunctional (meth)acrylate compound means a compound having one (meth)acryloyl group, and a polyfunctional (meth)acrylate compound means a compound having two or more (meth)acryloyl groups. A (meth)acrylic resin means a (co) polymer having at least a structural unit derived from a (meth)acrylate compound. A (meth)acryloyl group means an acryloyl group or a corresponding methacryloyl group. The same applies to other similar expressions such as (meth)acrylate. Further, “A or B” may include either one of A and B, or both.

In the present specification, a cyclic ether group means a group obtained by removing one hydrogen atom directly bonded to a carbon atom from a compound having a cyclic ether such as oxirane or oxetane. The cyclic ether group may be a group obtained by removing one hydrogen atom directly bonded to a carbon atom from a compound having a three-membered or four-membered cyclic ether. Examples of such a cyclic ether group include an epoxy group (oxiranyl group), an oxetanyl group, and the like, as well as an alicyclic epoxy group (an epoxy group formed together with two carbon atoms constituting an alicyclic ring) such as an epoxycyclohexyl group.

Unless otherwise specified, the materials exemplified below may be used alone or in combination of two or more. The amount used or content of each component means the total amount of the plurality of substances corresponding to each component present in the composition, unless otherwise specified, when a plurality of substances corresponding to each component exist in the composition.

### [Adhesive Composition]

The adhesive composition of one embodiment contains a monofunctional (meth)acrylate compound (hereinafter, may be referred to as “component (A)”), a polyfunctional (meth)acrylate compound (hereinafter, may be referred to as “component (B)”), an epoxy compound (hereinafter, may be referred to as “component (C)”), a cross-linking agent (hereinafter, may be referred to as “component (D)”), and a photoacid generator (hereinafter, may be referred to as “component (E)”). The adhesive composition may further contain, for example, a coupling agent (hereinafter, may be referred to as “component (F)”), a photoradical generator (hereinafter, may be referred to as “component (G)”), and the like.

(A) Component: Monofunctional (meth)acrylate Compound

Component (A) includes a (meth)acrylate having a fluorine-containing organic group (hereinafter, may be referred to as “component (A1)”). Component (A) may further include a (meth)acrylate having a hydroxy group (hereinafter, may be referred to as “component (A2)”). Component (A) may further include a (meth)acrylate having an alkoxy group (hereinafter, may be referred to as “component (A3)”).

Since component (A) includes component (A1), a reduction in refractive index becomes possible in the cured product of the adhesive composition. Component (A1) may be, for example, a (meth)acrylate having a fluoroalkyl group. Examples of the (meth)acrylate having a fluoroalkyl group include trifluoromethyl (meth)acrylate, 2,2,2-trifluoroethyl (meth)acrylate, 1,1,1,3,3,3-hexafluoro-2-propyl (meth)acrylate, perfluoroethylmethyl (meth)acrylate, perfluoropropylmethyl (meth)acrylate, perfluorobutylmethyl (meth)acrylate, perfluoropentylmethyl (meth)acrylate, perfluorohexylmethyl (meth)acrylate, perfluoroheptylmethyl (meth)acrylate, perfluorooctylmethyl (meth)acrylate, perfluorononylmethyl (meth)acrylate, perfluorodecylmethyl (meth)acrylate, perfluoroundecylmethyl (meth)acrylate, perfluorododecylmethyl (meth)acrylate, perfluorotridecylmethyl (meth)acrylate, perfluorotetradecylmethyl (meth)acrylate, 2-(trifluoromethyl)ethyl (meth)acrylate, 2-(perfluoroethyl)ethyl (meth)acrylate, 2-(perfluoropropyl)ethyl (meth)acrylate, 2-(perfluorobutyl)ethyl (meth)acrylate, 2-(perfluoropentyl)ethyl (meth)acrylate, 2-(perfluorohexyl)ethyl (meth)acrylate, 2-(perfluoroheptyl)ethyl (meth)acrylate, 2-(perfluorooctyl)ethyl (meth)acrylate, 2-(perfluorononyl)ethyl (meth)acrylate, 2-(perfluorotridecyl)ethyl (meth)acrylate, 2-(perfluorotetradecyl)ethyl (meth)acrylate, 1H,1H,5H-octafluoropentyl (meth)acrylate, and the like.

In the (meth)acrylate having a fluoroalkyl group as component (A1), the number of carbon atoms of the fluoroalkyl group may be, for example, 1 to 20, may be 2 or more, 3 or more, 4 or more, or 6 or more, and may be 18 or less, 16 or less, 14 or less, or 12 or less, from the viewpoint of reducing the refractive index of the cured product.

In the (meth)acrylate having a fluoroalkyl group as component (A1), the proportion of fluorine atoms in the fluoroalkyl group is calculated based on the total amount of hydrogen atoms and fluorine atoms directly bonded to the carbon atoms constituting the fluoroalkyl group. For example, in the trifluoromethyl group of trifluoromethyl (meth)acrylate, since there are 3 fluorine atoms and 0 hydrogen atoms, the proportion of fluorine atoms is 100%. For example, in the 2,2,2-trifluoroethyl group of 2,2,2-trifluoroethyl (meth)acrylate, since there are 3 fluorine atoms and 2 hydrogen atoms, the proportion of fluorine atoms is 60%. The proportion of the fluorine atoms may be, for example, 100% or less, 90% or less, or 80% or less, and may be 30% or more, 40% or more, or 50% or more, from the viewpoint of reducing the refractive index of the cured product.

The content of component (A1) may be 5 mass % or more, 15 mass % or more, 25 mass % or more, 30 mass % or more, 35 mass % or more, 40 mass % or more, or 45 mass % or more, and may be 70 mass % or less, 65 mass % or less, or 60 mass % or less, based on the total amount of component (A), from the viewpoint of reducing the refractive index of the cured product.

When component (A) includes component (A2), the curability and adhesion of the adhesive composition can be further improved. Component (A2) may be, for example, a (meth)acrylate having a hydroxyalkyl group. Examples of the (meth)acrylate having a hydroxyalkyl group include 2-hydroxyethyl (meth)acrylate, 2-hydroxypropyl (meth)acrylate, 3-hydroxypropyl (meth)acrylate, 4-hydroxybutyl (meth)acrylate, and the like.

The content of component (A2) may be 0.1 mass % or more, 1 mass % or more, or 2 mass % or more, and may be 15 mass % or less, 12 mass % or less, 10 mass % or less, or 8 mass % or less, based on the total amount of component (A), from the viewpoint of the curability and adhesion of the adhesive composition.

When component (A) includes component (A3), the solubility of component (D) described later can be further improved, and furthermore, the transmittance of the cured product of the adhesive composition can be further improved. Component (A3) may be, for example, a (meth)acrylate having an alkoxyalkyl group. Examples of component (A3) include 2-methoxyethyl acrylate, 2-ethoxyethyl (meth)acrylate, and the like.

The content of component (A3) may be 5 mass % or more, 10 mass % or more, 20 mass % or more, 30 mass % or more, or 35 mass % or more, and may be 65 mass % or less, 60 mass % or less, 55 mass % or less, or 50 mass % or less, based on the total amount of component (A), from the viewpoint of the solubility of component (D).

Component (A) may include other (meth)acrylates (hereinafter, may be referred to as “component (A4)”) to the extent that the effects of the present disclosure are not impaired. Examples of component (A4) include monofunctional (meth)acrylates having one (meth)acryloyl group other than component (A1), component (A2), and component (A3).

Examples of component (A4) include: alkyl (meth)acrylates having an alkyl group such as methyl (meth)acrylate, ethyl (meth)acrylate, n-butyl (meth)acrylate, isobutyl (meth)acrylate, tert-butyl (meth)acrylate, n-hexyl (meth)acrylate, n-octyl (meth)acrylate, isooctyl (meth)acrylate, 2-ethylhexyl (meth)acrylate, isodecyl (meth)acrylate, and dodecyl (meth)acrylate; alkenyl (meth)acrylates having an alkenyl group such as 3-butenyl (meth)acrylate; (meth)acrylates having an aromatic group such as benzyl and phenoxyethyl (meth)acrylate; (meth)acrylates having an alicyclic group such as cyclohexyl (meth)acrylate, isobornyl (meth)acrylate, and dicyclopentanyl (meth)acrylate; (meth)acrylates having a heterocyclic group such as 4-(meth)acryloylmorpholine; alkoxypolyalkylene glycol (meth)acrylates such as methoxyethylene glycol (meth)acrylate, methoxytetraethylene glycol (meth)acrylate, methoxyhexaethylene glycol (meth)acrylate, and methoxyoctaethylene glycol (meth)acrylate; polyalkylene glycol mono(meth)acrylates such as tetraethylene glycol mono(meth)acrylate, hexaethylene glycol mono(meth)acrylate, and octapropylene glycol mono(meth)acrylate; and (meth)acrylates having a siloxane skeleton.

The content of component (A4) may be 0 to 45 mass %, 0 to 40 mass %, 0 to 30 mass %, 0 to 25 mass %, 0 to 10 mass %, or 0 to 5 mass %, based on the total amount of component (A).

The content of component (A) (total amount of component (A1), component (A2), component (A3), and component (A4)) may be 20 mass % or more, 25 mass % or more, or 30 mass % or more, and may be 60 mass % or less, 55 mass % or less, 50 mass % or less, or 45 mass % or less, based on the total amount of the adhesive composition.

(B) Component: Polyfunctional (meth)acrylate Compound

When the adhesive composition contains component (B), a polymer with a network structure is formed together with component (A), which makes it possible to provide a cured product in which adhesive strength is sufficiently maintained before and after a damp heat test.

Examples of component (B) include: difunctional (meth)acrylates such as ethylene glycol di(meth)acrylate, diethylene glycol di(meth)acrylate, polyethylene glycol di(meth)acrylate, dipropylene glycol di(meth)acrylate, tripropylene glycol di(meth)acrylate, polypropylene glycol di(meth)acrylate, 1,9-nonanediol di(meth)acrylate, polyethylene glycol di(meth)acrylate, tetraethylene glycol di(meth)acrylate, 1,6-hexanediol di(meth)acrylate, neopentyl glycol di(meth)acrylate, 1,3-bis((meth)acryloyloxy)-2-propanol, dioxane glycol di(meth)acrylate, isocyanuric acid EO-modified di(meth)acrylate, dimethyloltricyclodecane di(meth)acrylate, and 1,3-adamantanediol di(meth)acrylate; trifunctional (meth)acrylates such as trimethylolpropane tri(meth)acrylate, pentaerythritol tri(meth)acrylate, trimethylolpropane EO-modified tri(meth)acrylate, trimethylolpropane PO-modified tri(meth)acrylate, glycerin PO-modified tri(meth)acrylate, and isocyanuric acid EO-modified tri(meth)acrylate; tetrafunctional (meth)acrylates such as pentaerythritol tetra(meth)acrylate, sorbitol tetra(meth)acrylate, ditrimethylolpropane tetra(meth)acrylate, and propionic acid dipentaerythritol tetra(meth)acrylate; pentafunctional (meth)acrylates such as sorbitol penta(meth)acrylate; and hexafunctional (meth)acrylates such as dipentaerythritol hexa(meth)acrylate, sorbitol hexa(meth)acrylate, alkylene oxide-modified hexa(meth)acrylate of phosphazene, and caprolactone-modified dipentaerythritol hexa(meth)acrylate.

Component (B) may include a trifunctional or higher (meth)acrylate compound because the effects of the present disclosure are more likely to be sufficiently obtained. The trifunctional or higher (meth)acrylate compound may be a decafunctional or lower (meth)acrylate compound, and may be an octafunctional or lower (meth)acrylate compound or a hexafunctional or lower (meth)acrylate compound.

Component (B) may be an acrylate compound having an acryloyl group and no methacryloyl group, or a methacrylate compound having a methacryloyl group and no acryloyl group. Component (B) may be an acrylate compound having an acryloyl group and no methacryloyl group because the effects of the present disclosure are more likely to be sufficiently obtained.

The content of component (B) may be 0.1 mass % or more, 0.5 mass % or more, or 1 mass % or more, and may be 15 mass % or less, 10 mass % or less, or 5 mass % or less, based on the total amount of the adhesive composition.

### (C) Component: Epoxy Compound

Component (C) is a compound having one or more epoxy groups. Component (C) may be a compound having two or more epoxy groups. Component (C) may include an aliphatic epoxy compound (hereinafter, may be referred to as “component (C1)”). Component (C) may include an alicyclic epoxy compound (hereinafter, may be referred to as “component (C2)”). Component (C) may include both component (C1) and component (C2).

When component (C) includes component (C1), the compatibility and cross-linkability of the adhesive composition tend to improve. Component (C1) may be an aliphatic diglycidyl ether having at least one aliphatic group (linking group) selected from the group consisting of an alkylene group, an oxyalkylene group, and a cycloalkylene group. Further, component (C1) may be an epoxy compound having no aromatic ring.

Examples of the aliphatic diglycidyl ether include: diglycidyl ethers having an alkylene group such as ethylene glycol diglycidyl ether, propylene glycol diglycidyl ether, neopentyl glycol diglycidyl ether, 1,4-butanediol diglycidyl ether, and 1,6-hexanediol diglycidyl ether; diglycidyl ethers having an oxyalkylene group such as diethylene glycol diglycidyl ether, tripropylene glycol diglycidyl ether, and polyethylene glycol diglycidyl ether; and diglycidyl ethers having a cycloalkylene group such as hydrogenated bisphenol A diglycidyl ether, 1,4-cyclohexanedimethanol diglycidyl ether, diglycidyl-1,2-cyclohexanedicarboxylate.

The content of component (C1) may be 10 mass % or more, 20 mass % or more, 30 mass % or more, 40 mass % or more, 50 mass % or more, or 60 mass % or more, and may be 100 mass % or less, 90 mass % or less, or 85 mass % or less, based on the total amount of component (C).

Component (C2) is a compound having an epoxy group (for example, an epoxycyclohexyl group) formed together with two carbon atoms constituting an alicyclic ring. When component (C) includes component (C2), the heat resistance and cross-linkability of the adhesive composition tend to improve. Examples of commercially available products of component (C2) include Celloxide 8010, Celloxide 2021P, and Celloxide 2081 (trade names, all manufactured by Daicel Corporation). Further, component (C2) may be an epoxy compound having no aromatic ring.

The content of component (C2) may be 0 mass % or more, 10 mass % or more, or 15 mass % or more, and may be 90 mass % or less, 80 mass % or less, 70 mass % or less, 60 mass % or less, 50 mass % or less, or 40 mass % or less, based on the total amount of component (C).

Component (C) may include other epoxy compounds (hereinafter, may be referred to as “component (C3)”) in addition to component (C1) and component (C2) to the extent that the effects of the present disclosure are not impaired. Examples of the other epoxy compounds include epoxy compounds having an aromatic ring.

Examples of component (C3) include diglycidyl phthalate, bisphenol A type epoxy resin, bisphenol F type epoxy resin, bisphenol AD type epoxy resin, bisphenol S type epoxy resin, phenol novolac type epoxy resin, cresol novolac type epoxy resin, biphenyl type epoxy resin, and biphenyl aralkyl type epoxy resin.

The content of component (C3) may be 0 to 40 mass %, 0 to 30 mass %, 0 to 20 mass %, or 0 to 10 mass %, based on the total amount of component (C).

The content of component (C) (total amount of component (C1), component (C2), and component (C3)) may be 5 mass % or more, 10 mass % or more, 15 mass % or more, or 20 mass % or more, and may be 50 mass % or less, 45 mass % or less, or 40 mass % or less, based on the total amount of the adhesive composition.

### (D) Component: Cross-Linking Agent

Component (D) includes a (meth)acrylic resin having a first structural unit derived from a (meth)acrylate having a fluorine-containing organic group, and a second structural unit derived from a (meth)acrylate having a cyclic ether group. The cross-linking agent may consist of the (meth)acrylic resin.

The (meth)acrylate having a fluorine-containing organic group that provides the first structural unit may be, for example, a (meth)acrylate having a fluoroalkyl group. Examples of the (meth)acrylate having a fluoroalkyl group include those exemplified for component (A1).

In the (meth)acrylate having a fluoroalkyl group, the number of carbon atoms of the fluoroalkyl group may be, for example, 1 to 10, may be 2 or more, and may be 8 or less, 6 or less, 4 or less, or 3 or less, from the viewpoint of compatibility with component (A) or its polymer.

In the (meth)acrylate having a fluoroalkyl group, the proportion of fluorine atoms in the fluoroalkyl group may be, for example, 100% or less, 80% or less, or 70% or less, and may be 30% or more, 40% or more, or 50% or more, from the viewpoint of compatibility with component (A) or its polymer.

The content of the first structural unit may be 10 to 90 mol %, 20 to 90 mol %, 30 to 90 mol %, or 40 to 90 mol %, based on all structural units of the (meth)acrylic resin, from the viewpoint of compatibility with component (A) or its polymer.

The (meth)acrylate having a cyclic ether group that provides the second structural unit may be, for example, at least one selected from the group consisting of a (meth)acrylate having an epoxy group, a (meth)acrylate having an alicyclic epoxy group, and a (meth)acrylate having an oxetanyl group. Examples of the (meth)acrylate having an epoxy group include glycidyl (meth)acrylate and the like. Examples of the (meth)acrylate having an alicyclic epoxy group include 3,4-epoxycyclohexylmethyl (meth)acrylate and the like. Examples of the (meth)acrylate having an oxetanyl group include (3-ethyloxetan-3-yl)methyl (meth)acrylate and the like.

In the (meth)acrylic resin, the content of the second structural unit may be 10 to 90 mol %, 10 to 80 mol %, 10 to 70 mol %, or 10 to 60 mol %, based on all structural units of the (meth)acrylic resin, from the viewpoint of cross-linkability with component (B).

The (meth)acrylic resin may have other structural units other than the first structural unit and the second structural unit to the extent that the effects of the invention of the present disclosure are not impaired. Examples of compounds that provide other structural units include: monofunctional (meth)acrylates having one (meth)acryloyl group such as alkyl (meth)acrylates having an alkyl group, (meth)acrylates having an aromatic group, (meth)acrylates having an alicyclic group, (meth)acrylates having a nitrogen- and oxygen-containing heterocyclic group, alkoxypolyalkylene glycol (meth)acrylates, polyalkylene glycol mono(meth)acrylates, and (meth)acrylates having a siloxane skeleton; polyfunctional (meth)acrylates having two or more (meth)acryloyl groups such as aliphatic poly(meth)acrylates and aromatic poly(meth)acrylates; and compounds having a radically polymerizable group other than a (meth)acryloyl group, such as styrene, 4-methylstyrene, vinylpyridine, vinylpyrrolidone, vinyl acetate, cyclohexylmaleimide, and phenylmaleimide.

The content of the other structural units may be 0 to 40 mol %, 0 to 30 mol %, 0 to 20 mol %, or 0 to 10 mol %, based on all structural units of the (meth)acrylic resin.

The weight-average molecular weight (Mw) of the (meth)acrylic resin may be, for example, 1,000 to 200,000, may be 3,000 or more, 5,000 or more, or 10,000 or more, and may be 150,000 or less, 100,000 or less, 60,000 or less, or 50,000 or less. The weight-average molecular weight (Mw) is a polystyrene-equivalent value using a calibration curve by standard polystyrene in gel permeation chromatography (GPC). The weight-average molecular weight (Mw) can be measured, for example, by the method described in the Examples.

The (meth)acrylic resin can be obtained by radical polymerization using, for example, a solution polymerization method. More specifically, it can be obtained by polymerizing monomers including a (meth)acrylate having a cyclic ether group and a (meth)acrylate having a fluorine-containing organic group in a solvent.

As the solvent, an organic solvent generally used in the field of radical polymerization can be appropriately selected and used. The solvent may be a solvent that has a cyclic ether group (epoxy group or oxetanyl group) and does not have a radically polymerizable group, because the cross-linking agent ((meth)acrylic resin) can be directly blended for the curing reaction without an isolation step (without removing and replacing the solvent). Examples of the solvent include those generally used in the field of diluents for epoxy resins. Further, examples of the solvent include epoxy resins that are liquid at 25° C. The solvent may be, for example, an aliphatic diglycidyl ether from the viewpoint that it can be used as component (C1). Examples of the aliphatic diglycidyl ether include those exemplified for component (C1).

In the present specification, a radically polymerizable group means a group having a carbon-carbon double bond. Examples of the radically polymerizable group include a (meth)acryloyl group, a vinyl group, an allyl group, a styryl group, an alkenyl group, an alkenylene group, a maleimide group, and the like.

The amount of the solvent used can be appropriately set according to the type of monomer, reaction conditions, the proportion of solid content in the (meth)acrylic resin solution, and the like.

When polymerizing the monomers, a thermal radical generator, additives, and the like may be added as necessary.

Examples of the thermal radical generator include: organic peroxides such as cumene hydroperoxide, diisopropylbenzene hydroperoxide, di-t-butyl peroxide, lauroyl peroxide, benzoyl peroxide, t-butyl peroxyisopropyl carbonate, t-amyl peroxy-2-ethylhexanoate, and t-butyl peroxy-2-ethylhexanoate; and azo compounds such as 2,2′-azobis(isobutyronitrile), 1,1′-azobis(cyclohexanecarbonitrile), 2,2′-azobis(2,4-dimethylvaleronitrile), and dimethyl-2,2′-azobis(2-methylpropionate).

The addition amount of the thermal radical generator may be appropriately set according to the type of monomer, reaction conditions, and the like, and is not particularly limited, but may be 100 to 200,000 mass ppm, 100 to 100,000 mass ppm, 1,000 to 100,000 mass ppm, 1,000 to 50,000 mass ppm, 3,000 to 30,000 mass ppm, or 10,000 to 80,000 mass ppm, based on the total amount of the monomers.

Examples of the additives include a chain transfer agent, an antioxidant, a light stabilizer, a weather stabilizer, an ultraviolet absorber, a radical scavenger, and the like. The addition amount of the additives is not particularly limited, but may be 0.001 to 2 mass % or 0.005 to 1 mass %, based on the total amount of the monomers.

The polymerization temperature may be 40 to 120° C., 50 to 100° C., or 60 to 90° C. Further, the polymerization time may be 0.1 to 24 hours, 0.5 to 20 hours, or 1 to 12 hours.

The content of component (D) may be 5 mass % or more, 8 mass % or more, 10 mass % or more, 12 mass % or more, or 15 mass % or more, and may be 40 mass % or less, 35 mass % or less, or 30 mass % or less, based on the total amount of the adhesive composition.

### (E) Component: Photoacid Generator

Component (E) may be a component that generates an acid that initiates polymerization upon irradiation with light including a wavelength in the range of 150 to 750 nm or light including a wavelength in the range of 254 to 405 nm. Component (E) may be a component that generates a radical and an acid upon irradiation with ultraviolet light.

Examples of component (E) include onium salts such as sulfonium salts, phosphonium salts, ammonium salts, diazonium salts, iodonium salts, and anilinium salts. Examples of the anion of the onium salt include BF₄⁻, BR₄⁻ (R represents a phenyl group substituted with two or more fluorine atoms or two or more trifluoromethyl groups), PF₆⁻, SbF₆⁻, AsF₆⁻, SO₄R⁻ (R represents an alkyl group), and the like.

Examples of commercially available products of component (E) include CPI-100P, CPI-110P, CPI-101A, CPI-200K, CPI-210S (all manufactured by SAN-APRO Ltd.), UVI-6990, UVI-6992, UVI-6976 (all manufactured by Dow Chemical Japan Ltd.), SP-150, SP-152, SP-170, SP-172, SP-300 (all manufactured by ADEKA CORPORATION), and the like.

The content of component (E) may be, for example, 0.1 parts by mass or more, 0.5 parts by mass or more, or 1 part by mass or more, and may be 15 parts by mass, 10 parts by mass or less, or 8 parts by mass or less, with respect to 100 parts by mass of the total amount of component (C) and component (D).

### (F) Component: Coupling Agent

Component (F) may be, for example, a silane coupling agent. The silane coupling agent may be, for example, a compound having a hydrolyzable silyl group and a functional group that can react with either a (meth)acrylate compound or an epoxy compound. The hydrolyzable silyl group is, for example, a group having a silicon atom and one to three alkoxy groups bonded to the silicon atom. The number of carbon atoms of the alkoxy group bonded to the silicon atom may be, for example, 1 to 4. Examples of the functional group include an amino group such as a primary amino group or a secondary amino group, an epoxy group, a mercapto group, a (meth)acryloyl group, an isocyanate group, and the like. The functional group may be an isocyanate group because the effects of the present disclosure are more likely to be sufficiently obtained. That is, component (F) may include a silane coupling agent having an isocyanate group. In the present specification, a compound having a hydrolyzable silyl group and a (meth)acryloyl group, and a compound having a hydrolyzable silyl group and an epoxy group are classified as silane coupling agents.

Examples of commercially available products of the silane coupling agent include KBM-303, KBM-402, KBM-403, KBE-402, KBE-403, KBM-4803, KBM-502, KBM-503, KBE-502, KBE-503, KBM-5103, KBM-5803, KBM-602, KBM-603, KBM-903, KBE-903, KBE-9103P, KBM-573, KBM-575, KBM-802, KBM-803, and KBE-9007N (trade names, manufactured by Shin-Etsu Chemical Co., Ltd.).

The content of component (F) may be 0.1 mass % or more, 0.2 mass % or more, or 0.3 mass % or more, and may be 10 mass % or less, 8 mass % or less, 5 mass % or less, 3 mass % or less, or 2 mass % or less, based on the total amount of the adhesive composition.

### (G) Component: Photoradical Generator

Component (G) may be a component that generates a radical upon irradiation with light including a wavelength in the range of 150 to 750 nm or light including a wavelength in the range of 254 to 405 nm. Component (G) may be a component that generates a radical upon irradiation with ultraviolet light. Component (G) may be a component that mainly acts on component (A).

Component (G) decomposes by light to generate a free radical. That is, component (G) is a compound that generates a radical by application of external light energy. Component (G) may be a compound having a structure such as an oxime ester structure, a bisimidazole structure, an acridine structure, an α-aminoalkylphenone structure, an aminobenzophenone structure, an N-phenylglycine structure, an acylphosphine oxide structure, a benzyldimethylketal structure, or an α-hydroxyalkylphenone structure. Component (G) may be, for example, a compound having a structure selected from the group consisting of an oxime ester structure, an α-aminoalkylphenone structure, and an acylphosphine oxide structure, and may be a compound having an acylphosphine oxide structure.

Specific examples of the compound having an oxime ester structure include 1-phenyl-1,2-butanedione-2-(o-methoxycarbonyl) oxime, 1-phenyl-1,2-propanedione-2-(o-methoxycarbonyl) oxime, 1-phenyl-1,2-propanedione-2-(o-ethoxycarbonyl) oxime, 1-phenyl-1,2-propanedione-2-o-benzoyloxime, 1,3-diphenylpropanetrione-2-(o-ethoxycarbonyl) oxime, 1-phenyl-3-ethoxypropanetrione-2-(o-benzoyl) oxime, and the like.

Specific examples of the compound having an α-aminoalkylphenone structure include 2-methyl-1-[4-(methylthio)phenyl]-2-morpholinopropan-1-one, 2-benzyl-2-dimethylamino-1-morpholinophenyl-butanone-1, and the like.

Specific examples of the compound having an acylphosphine oxide structure include bis(2,6-dimethoxybenzoyl)-2,4,4-trimethyl-pentylphosphine oxide, bis(2,4,6,-trimethylbenzoyl)phenylphosphine oxide, diphenyl(2,4,6-trimethylbenzoyl)phosphine oxide, and the like.

The content of component (G) may be, for example, 0.1 to 15 parts by mass, 0.5 to 10 parts by mass, or 1 to 8 parts by mass, with respect to 100 parts by mass of the total amount of component (A) and component (B).

The adhesive composition may contain other components. Examples of the other components include an antioxidant, a photosensitizer, and the like.

The content of the antioxidant may be 0.1 to 10 mass % based on the total amount of the adhesive composition.

Examples of the photosensitizer include benzoflavin, anthracene, pyrene, thioxanthone, benzophenone, anthraquinone, camphorquinone, coumarin-based dyes, oxazole compounds, and the like.

The content of the photosensitizer may be 0.01 to 10 mass %, and may be 0.01 to 1 mass %, based on the total amount of the adhesive composition.

The adhesive composition can be prepared by mixing (or kneading) component (A), component (B), component (C), component (D), and component (E), as well as component (F), component (G), and other components. The mixing can be performed by appropriately combining a normal stirrer, a dispersion machine such as a planetary centrifugal mixer, and the like. Further, in the mixing, a defoaming treatment may be performed by vacuum deaeration or the like as appropriate.

The adhesive composition can form an adhesive part (adhesive layer) having excellent adhesion to various adherends. The adhesive part can be obtained by placing the adhesive composition at a predetermined position and irradiating the placed adhesive composition with light. The adhesive part contains a cured product of the adhesive composition. The light irradiation may be performed directly on the adhesive composition, or may be performed through a transparent resin, glass, or the like.

The light for light irradiation may be light including a wavelength in the range of 150 to 750 nm or light including a wavelength in the range of 254 to 405 nm, and may be ultraviolet light.

Examples of the light source for light irradiation include a low-pressure mercury lamp, a medium-pressure mercury lamp, a high-pressure mercury lamp, an ultra-high-pressure mercury lamp, a xenon lamp, a metal halide lamp, an LED light source, and the like. The integrated light quantity of the light irradiation can be appropriately set, and may be, for example, 100 to 5000 mJ/cm².

The atmosphere for light irradiation is not particularly limited, but may be, for example, an air atmosphere, or an inert gas atmosphere such as nitrogen or argon.

The infrared transmittance of the cured product of the adhesive composition may be 70% or more, and may be 75% or more, 80% or more, 85% or more, or 90% or more. The infrared transmittance can be determined by measuring the transmittance at a wavelength of 1310 nm using a spectrophotometer. A measurement sample can be prepared by the following procedure. First, a spacer film with a thickness of 500 μm is placed on a release film so that the dimensions are 50 mm wide×50 mm long and 500 μm thick, and the adhesive composition is applied onto the release film. Next, the adhesive composition is irradiated with light using an LED lamp (manufactured by USHIO INC., wavelength: 365 nm) under conditions of 30 mW/cm² for 30 seconds, and the product after 600 seconds have elapsed since the end of the light irradiation is peeled off from the release film to be used as a measurement sample. Further, the glass used as the substrate can be used for the baseline measurement.

### [Bonded Object]

The bonded object of one embodiment includes a first adherend, a second adherend, and an adhesive part that bonds the first adherend and the second adherend to each other. The adhesive part contains a cured product of the above-described adhesive composition.

Examples of the first adherend and the second adherend include: organic materials such as polyolefin resin, polyamide resin, ABS (acrylonitrile-butadiene-styrene) resin, PC (polycarbonate) resin, PET (polyethylene terephthalate) resin, PPS (polyphenylene sulfide) resin, acrylic resin, and transparent resin; inorganic materials such as steel, stainless steel, metals (aluminum, copper, nickel, chromium, etc.) alone or alloys of these metals, glass, and silicon wafers; wood; and rubber. Further, examples of the first adherend 1 and the second adherend 2 also include materials in which the above-mentioned plastics and the above-mentioned inorganic materials are combined. Either the first adherend 1 or the second adherend 2 may be a transparent resin or glass from the viewpoint of light irradiation.

The thickness of the first adherend and the second adherend may be, for example, 0.1 to 2.0 mm, 0.1 to 1.0 mm, or 0.1 to 0.5 mm.

The bonded object can be obtained by a method including applying the adhesive composition onto the first adherend to form an adhesive part, placing the second adherend on the adhesive part precursor to produce a laminate, and irradiating the adhesive part of the laminate with light to form an adhesive part containing a cured product of the adhesive composition.

The adhesive composition can be applied using a knife coater, a roll coater, an applicator, a comma coater, a die coater, a dispenser, or the like.

The light irradiation conditions (light wavelength, light source, integrated light quantity, etc.) for the adhesive part of the laminate may be the same as the above-described light irradiation conditions (light wavelength, light source, integrated light quantity, etc.).

The thickness of the adhesive part containing the cured product of the adhesive composition may be, for example, 0.01 to 1.0 mm, 0.01 to 0.5 mm, or 0.01 to 0.2 mm.

### EXAMPLES

Hereinafter, the present disclosure will be specifically described with reference to Examples, but the present disclosure is not limited to these Examples.

### [Synthesis of (Meth)acrylic Resin (Cross-Linking Agent)]

The following raw materials were prepared.

### (Meth)acrylate Compound

M-3F: 2,2,2-trifluoroethyl methacrylate (LIGHT ESTER M-3F, KYOEISHA CHEMICAL Co., LTD.)
TTA-15:3,4-epoxycyclohexylmethyl methacrylate (manufactured by Sun Chemical Corporation)

### Thermal Radical Generator

V-601: Dimethyl-2,2′-azobis(2-methylpropionate) (FUJIFILM Wako Pure Chemical Corporation)

### Solvent

NPG (D): Neopentyl glycol diglycidyl ether (Epogosei NPG (D)) (Yokkaichi Chemical Company, Limited)

### Production Example 1

144.38 g of M-3F and 42.13 g of TTA-15 (mole ratio of M-3F/TTA-15=80%/20%), 5.78 g of V-601, and 24.11 g of NPG (D) were mixed to prepare a mixture (a). Separately, 1.87 g of V-601 was dissolved in 7.46 g of NPG (D) to prepare a solution (b).

Into a flask equipped with a stirrer, a dropping funnel, a condenser, a thermometer, and a gas inlet tube, 162.44 g of NPG (D) was charged, stirred while purging with nitrogen gas under a nitrogen atmosphere, and heated to 85° C. Next, the mixture (a) was dropped into the flask over 2 hours. After the dropping was completed, the mixture was stirred at 85° C. for 20 minutes, then the solution (b) was added, and the mixture was further stirred for 7 hours. Next, while continuing to stir, the mixture was cooled to room temperature (25° C.) to obtain a solution containing the (meth)acrylic resin (cross-linking agent A) of Production Example 1. The solid content concentration was 50 mass %.

### [Evaluation of (Meth)Acrylic Resin (Cross-Linking Agent)] (Measurement of Viscosity (25° C.))

The viscosity at 25° C. of the solution containing the (meth)acrylic resin was measured under the condition of a rotation speed of 10 rpm after setting 0.5 to 1.0 mL of the sample in an E-type viscometer (manufactured by TOKI SANGYO CO., LTD., product name: VISCOMETER-TV22, applicable cone plate type rotor: 3°×R17.65). The results are shown in Table 1.

### (Measurement of Weight-Average Molecular Weight (Mw))

As a sample for Mw measurement, a 0.2 mass % THF solution was prepared by dissolving the solution containing the (meth)acrylic resin in tetrahydrofuran (THF). The Mw was measured by gel permeation chromatography (GPC) and derived by conversion using a calibration curve of standard polystyrene. The GPC conditions are shown below. The results are also shown in Table 1.
Measurement device: Shodex (registered trademark) GPC-101 (manufactured by Resonac Corporation)
Detector: Differential refractometer Shodex RI-71S (manufactured by Resonac Corporation)
Column: Shodex LF-804+LF-804 (manufactured by Resonac Corporation)
Column temperature: 40° C.
Eluent: Tetrahydrofuran (THF)
Flow rate: 1 mL/min

TABLE 1

| | | Prod. Exam. 1 |
|---|---|---|
| | | Cross-linking agent A |
| (Meth)acrylate | M-3F | 80 |
| (Unit: mol %) | TTA-15 | 20 |
| Viscosity (25° C.) | Pa · s | 43.2 |

| | |
|---|---|
| Weight-average molecular weight (Mw) | 48000 |

### Preparation of Adhesive Composition

### Examples 1 to 13 and Comparative Example 1

Each component in the amounts (unit: parts by mass) shown in Table 2 and Table 3 was mixed with a planetary centrifugal mixer (5 min/1500 rpm) to prepare adhesive compositions of Examples 1 to 13 and Comparative Example 1 containing component (A), component (B), component (C), component (D), component (E), and component (F).

The details of each raw material are as follows.

(A) Component: Monofunctional (meth)acrylate Compound
V-13F: 1H,1H,2H,2H-tridecafluorooctyl acrylate (2-(perfluorohexyl)ethyl acrylate) (manufactured by OSAKA ORGANIC CHEMICAL INDUSTRY LTD.)
M3F: 2,2,2-trifluoroethyl acrylate (manufactured by KYOEISHA CHEMICAL Co., LTD.)
V-8F: 1H,1H,5H-octafluoropentyl acrylate (manufactured by OSAKA ORGANIC CHEMICAL INDUSTRY LTD.)
4-HBA: 4-hydroxybutyl acrylate (manufactured by OSAKA ORGANIC CHEMICAL INDUSTRY LTD.)
2-MTA: 2-methoxyethyl acrylate (manufactured by OSAKA ORGANIC CHEMICAL INDUSTRY LTD.)
   (B) Component: Polyfunctional (meth)acrylate Compound
A-9300S: Tris(2-acryloxyethyl) isocyanurate (trifunctional, isocyanuric acid EO-modified tri(meth)acrylate, manufactured by SHIN-NAKAMURA CHEMICAL CO., LTD.)
M-402: Dipentaerythritol hexaacrylate (hexafunctional, manufactured by TOAGOSEI CO., LTD.)
M-305: Pentaerythritol tri- and tetraacrylate (mixture of trifunctional and tetrafunctional, manufactured by TOAGOSEI CO., LTD.)
160S: Trimethylolpropane ethoxytriacrylate (TMPEOTA) (trimethylolpropane EO-modified triacrylate, trifunctional, manufactured by Daicel-Allnex Ltd.)
A-NPG: Neopentyl glycol diacrylate (difunctional, manufactured by SHIN-NAKAMURA CHEMICAL CO., LTD.)

### (C) Component: Epoxy Compound

NPG (D): Neopentyl glycol diglycidyl ether (Epogosei NPG (D)) (manufactured by Yokkaichi Chemical Company, Limited)
2021P: 3′,4′-epoxycyclohexylmethyl-3,4-epoxycyclohexanecarboxylate (Celloxide 2021P, manufactured by Daicel Corporation)

### (D) Component: Cross-Linking Agent

Cross-linking agent A: (Meth)acrylic resin of Production Example 1

### (E) Component: Photoacid Generator

CPI-110P: Sulfonium salt (manufactured by SAN-APRO Ltd.)

### (F) Component: Coupling Agent

KBM-403:3-glycidoxypropyltrimethoxysilane (manufactured by Shin-Etsu Chemical Co., Ltd.)
KBE-9007N: 3-isocyanatopropyltriethoxysilane (manufactured by Shin-Etsu Chemical Co., Ltd.)

The addition amounts of the (meth)acrylic resin (cross-linking agent A) of Production Example 1, which is component (D), and NPG (D), which is component (C), were adjusted using the solution containing the (meth)acrylic resin (cross-linking agent) obtained above.

### [Evaluation of Adhesive Composition]

### (Measurement of Shear Strength Before and After Damp Heat Test)

A spacer film with a thickness of 50 μm was placed on a slide glass so that the dimensions were 5 mm wide×5 mm long and 50 μm thick, and the adhesive composition was applied onto the slide glass. A glass chip with a width of 7 mm×7 mm and a thickness of 1.0 mm was placed on the applied adhesive composition, and the adhesive composition was irradiated with light using an LED lamp (manufactured by USHIO INC., wavelength: 365 nm) under conditions of 30 mW/cm² for 30 seconds, and the product after 270 seconds had elapsed since the end of the light irradiation was used as a measurement sample. A plurality of measurement samples were prepared for the measurement of shear strength after the damp heat test. For the measurement sample, the shear strength was measured using a bond tester (manufactured by Nordson Corporation, product name: DAGE4000) under the condition of a shear rate of 180 mm/min to measure the initial shear strength. The results are shown in Table 2 and Table 3. Next, using a measurement sample different from the one used for the measurement of the initial shear strength, a damp heat test (durability test under conditions of a temperature of 85° C., a humidity of 85% RH, and a time of 168 hours) was performed in a constant temperature and humidity chamber (manufactured by ETAC, product name: SXN402-E) to obtain a measurement sample after the damp heat test. For the measurement sample after the damp heat test, the shear strength after the damp heat test was measured under the same conditions as above. From the initial shear strength and the shear strength after the damp heat test, the strength retention rate (%) of the adhesive strength was determined based on the following formula. The results are shown in Table 2 and Table 3.

Strength retention rate (%) of adhesive strength=(Shear strength after damp heat test/Initial shear strength)×100

TABLE 2

| | | Comp. | | | | | | | | |
|---|---|---|---|---|---|---|---|---|---|---|
| | | Exam. 1 | Exam. 1 | Exam. 2 | Exam. 3 | Exam. 4 | Exam. 5 | Exam. 6 | Exam. 7 | Exam. 8 |
| (A) | V-13F | 40 | 40 | 40 | 40 | 40 | 40 | 40 | 40 | 40 |
| | 4-HBA | 5 | 5 | 5 | 5 | 5 | 5 | 5 | 5 | 5 |
| | 2-MTA | 25 | 25 | 25 | 25 | 25 | 25 | 25 | 25 | 25 |
| (B) | A-9300S | — | 10 | — | 5 | 5 | 10 | 10 | — | — |
| | M-402 | — | — | 10 | — | — | — | — | 10 | 10 |
| (C) | NPG(D) | 57.5 | 57.5 | 57.5 | 57.5 | 57.5 | 57.5 | 57.5 | 57.5 | 57.5 |
| | 2021P | 15 | 15 | 15 | 15 | 15 | 15 | 15 | 15 | 15 |
| (D) | Cross-linking | 57.5 | 57.5 | 57.5 | 57.5 | 57.5 | 57.5 | 57.5 | 57.5 | 57.5 |
| | agent A | | | | | | | | | |
| (E) | CPI-110P | 3 | 3 | 3 | 3 | 3 | 3 | 3 | 3 | 3 |
| (F) | KBM-403 | — | — | — | 1 | — | 1 | — | 1 | — |
| | KBE-9007N | — | — | — | — | 1 | — | 1 | — | 1 |

| | | | | | | | | | |
|---|---|---|---|---|---|---|---|---|---|
| Initial shear strength | 11 | 11 | 14 | 12 | 12 | 17 | 15 | 20 | 11 |
| (MPa) | | | | | | | | | |
| Adhesive strength | 9% | 27% | 21% | 83% | 117% | 59% | 93% | 55% | 91% |
| retention rate | | | | | | | | | |

TABLE 3

| | | Exam. 9 | Exam. 10 | Exam. 11 | Exam. 12 | Exam. 13 |
|---|---|---|---|---|---|---|
| (A) | V-13F | 40 | 40 | 40 | — | — |
| | M-3F | — | — | — | 40 | — |
| | V-8F | — | — | — | — | 40 |
| | 4-HBA | 5 | 5 | 5 | 5 | 5 |
| | 2-MTA | 25 | 25 | 25 | 25 | 25 |
| (B) | A-9300S | — | — | — | 10 | 10 |
| | M-305 | 10 | — | — | — | — |
| | 160S | — | 10 | — | — | — |
| | A-NPG | — | — | 10 | — | — |
| (C) | NPG(D) | 57.5 | 57.5 | 57.5 | 57.5 | 57.5 |
| | 2021P | 15 | 15 | 15 | 15 | 15 |
| (D) | Cross-linking | 57.5 | 57.5 | 57.5 | 57.5 | 57.5 |
| | agent A | | | | | |
| (E) | CPI-110P | 3 | 3 | 3 | 3 | 3 |
| (F) | KBE-9007N | 1 | 1 | 1 | 1 | 1 |

| | | | | | |
|---|---|---|---|---|---|
| Initial shear strength | 17 | 19 | 18 | 17 | 20 |
| (MPa) | | | | | |
| Adhesive strength | 93% | 95% | 91% | 93% | 92% |
| retention rate | | | | | |

As shown in Table 2 and Table 3, the adhesive compositions of Examples 1 to 13 containing component (B) were superior to the adhesive composition of Comparative Example 1 not containing component (B) in terms of the strength retention rate (strength maintenance rate) of the adhesive strength of the cured product. Further, from a comparison between Examples 1, 2 and Examples 3 to 13, it was found that the use of component (F) (silane coupling agent) tends to further improve the strength retention rate of the adhesive strength. Furthermore, from a comparison between Examples 3, 5, 7 and Examples 4, 6, 8, it was found that the use of a silane coupling agent having an isocyanate group as component (F) tends to further improve the strength retention rate of the adhesive strength. Such a tendency was also observed from Examples 9 to 13. From the above, it was confirmed that the adhesive composition of the present disclosure can provide a cured product having a sufficiently high strength retention rate of adhesive strength before and after a damp heat test.

1. An adhesive composition, comprising:
a monofunctional (meth)acrylate compound;
a polyfunctional (meth)acrylate compound;
an epoxy compound;
a cross-linking agent; and
a photoacid generator,
wherein
the monofunctional (meth)acrylate compound comprises a (meth)acrylate having a fluorine-containing organic group, and
the cross-linking agent comprises a (meth)acrylic resin having a first structural unit derived from a (meth)acrylate having a fluorine-containing organic group, and a second structural unit derived from a (meth)acrylate having a cyclic ether group.

2. The adhesive composition according to claim 1, wherein
the polyfunctional (meth)acrylate compound comprises a trifunctional or higher (meth)acrylate compound.

3. The adhesive composition according to claim 1, wherein
the epoxy compound comprises an aliphatic epoxy compound.

4. The adhesive composition according to claim 3, wherein
the epoxy compound further comprises an alicyclic epoxy compound.

5. A bonded object, comprising: a first adherend; a second adherend;
and an adhesive part that bonds the first adherend and the second adherend to each other, wherein the adhesive part comprises a cured product of the adhesive composition according to claim 1.

6. A bonded object, comprising: a first adherend; a second adherend; and an adhesive part that bonds the first adherend and the second adherend to each other, wherein
the adhesive part comprises a cured product of the adhesive composition according to claim 2.

7. A bonded object, comprising: a first adherend; a second adherend; and an adhesive part that bonds the first adherend and the second adherend to each other, wherein
the adhesive part comprises a cured product of the adhesive composition according to claim 3.

8. A bonded object, comprising: a first adherend; a second adherend; and an adhesive part that bonds the first adherend and the second adherend to each other, wherein
the adhesive part comprises a cured product of the adhesive composition according to claim 4.

9. The adhesive composition according to claim 1, wherein the monofunctional (meth)acrylate compound further comprises a (meth)acrylate having a hydroxy group.

10. The adhesive composition according to claim 9, wherein the monofunctional (meth)acrylate compound further comprises a (meth)acrylate having an alkoxy group.

11. The adhesive composition according to claim 1, wherein the polyfunctional (meth)acrylate compound is a polyfunctional acrylate.

12. The adhesive composition according to claim 1, further comprising a coupling agent.

13. The adhesive composition according to claim 12, wherein the coupling agent is a silane coupling agent having an isocyanate group.

14. The adhesive composition according to claim 1, wherein a content of the polyfunctional (meth)acrylate compound is 0.1 to 15 mass % based on a total amount of the adhesive composition.
